(19) United States
(12) Patent Application Publication
(10) Pub. No.: US 2019/0093463 A1
(43) Pub. Date: Mar. 28, 2019

(54) Hydraulic Fracturing with Nanobubbles

(71) Applicant: Nano Gas Technologies Inc, Deerfield, IL (US)

(72) Inventors: Jeffrey K Hardin, Wilmette, IL (US); Scott A Fiedler, Palantine, IL (US); Rudy M Folds, Abilene, TX (US)

(73) Assignee: Nano Gas Technologies Inc, Deerfield, IL (US)

(21) Appl. No.: 16/144,722

(22) Filed: Sep. 27, 2018

Related U.S. Application Data
(60) Provisional application No. 62/564,829, filed on Sep. 28, 2017.

(51) Int. Cl. E21B 43/26; C09K 8/70; C09K 8/80; C09K 8/92

(52) U.S. Cl. CPC E21B 43/26; C09K 8/70; C09K 2208/00; C09K 8/92; C09K 8/80

(57) ABSTRACT

Herein is provided a process which includes hydraulically fracturing a subterranean formation with a fracking fluid that includes a nanobubble solution. Alternatively, herein is provide a process that includes hydraulically fracturing a subterranean formation that includes nanobubbles with a fracking fluid that may or may not include a nanobubbles.

### CROSS-REFERENCE TO RELATED APPLICATIONS

This disclosure claims the benefit of priority to U.S. Prov. Application No. 62/564,829, filed Sep. 28, 2017, which is incorporated herein in its entirety.

### FIELD OF THE INVENTION

This disclosure related to the field of hydraulic fracturing and petroleum recovery.

### BACKGROUND

In the recovery of oil from a subterranean hydrocarbon-bearing formation, it is possible to recover only a portion of the oil in the formation using primary recovery methods that utilize the natural formation pressure to produce the oil. A portion of the oil that cannot be produced from the formation using primary recovery methods may be produced by improved or enhanced oil recovery (EOR) methods. Improved oil recovery methods include waterflooding.

Typically, further oil is produced from the formation after primary recovery by injecting water into the formation to mobilize oil for production from the formation. The injected water may drive a portion of the oil in the formation to a well for production from the formation. Oil not produced from the formation may be trapped within pores in the formation by capillary action of water extending across the pore throats of the pores. As a result, a significant quantity of oil located in the portions of the formation may be left in the formation and not recovered by the waterflood.

Improvements to methods of recovering oil from a hydrocarbon-bearing formation including those having oil trapped by water within pores of the formation are desirable.

### SUMMARY

One embodiment is a process that includes hydraulically fracturing a subterranean formation with a fracking fluid that includes nanobubbles.

Another embodiment is a process that includes forming a pressurized admixture of a gas and water; then converting the pressurized admixture to a nanogas solution which includes nanobubbles and water; injecting the nanogas solution into a subterranean formation; and then hydraulically fracturing the subterranean formation that includes the nanogas solution.

Yet another embodiment is a process that includes injecting a nanogas solution into a subterranean formation until the subterranean water includes a minimum concentration of nanobubbles, wherein the minimum concentration of the nanobubbles in the subterranean water is at least 0.01% of a concentration of nanobubbles in the nanogas solution; and then hydraulically fracturing the subterranean formation that includes the nanogas solution.

### BRIEF DESCRIPTION OF THE FIGURES

For a more complete understanding of the disclosure, reference should be made to the following detailed description and accompanying drawing figures wherein:

FIG. 1 is a schematic of a process claimed herein.

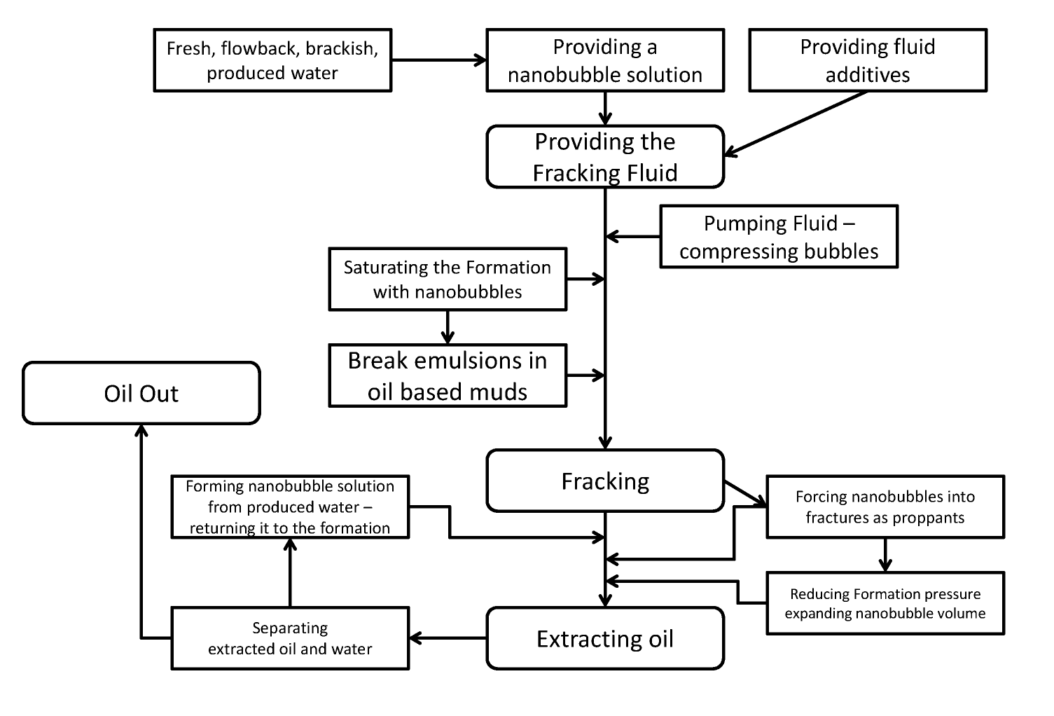

While specific embodiments are illustrated in the figures, with the understanding that the disclosure is intended to be illustrative, these embodiments are not intended to limit the invention described and illustrated herein.

### DETAILED DESCRIPTION

Objects, features, and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

Herein, the use of the word “a” or “an” when used in conjunction with the term “comprising” in the claims and/or the specification may mean “one,” but it is also consistent with the meaning of “one or more,” “at least one,” and “one or more than one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

One embodiment is a process that includes hydraulically fracturing a subterranean formation with a fracking fluid that includes a nanobubble solution. This process can further include hydraulically fracturing the subterranean formation and forcing nanobubbles into fractures. This process can further include reducing the pressure within the subterranean formation and expanding a diameter of the nanobubbles. Additionally, this process can include the nanobubbles function as proppants within the fractures.

In one instance, reducing the pressure within the subterranean formation expands a diameter of the nanobubbles, thereby expands the fractures. This process can further include providing the fracking fluid to the subterranean formation, where providing the fracking fluid includes forming a nanobubble solution external to the subterranean formation and pumping the fracking fluid into the subterranean formation. In one instance, the process of pressurizing the subterranean formation during the fracturing reduces the volume of each nanobubble in the nanobubble solution and increases the pressure within each nanobubble.

In yet another instance, the process can include providing a fracking fluid which includes forming a nanobubble solution within the subterranean formation, that is the nanobubbles can be formed down-hole or, alternatively, the nanobubbles can be formed on the surface and pumped down-hole with the fracking fluid. Typically, the fracking fluid includes fluid additives, for example those fluid additives are selected from biocides, surfactants, friction reducers, gellants, hard proppants, and mixtures thereof.

This process wherein forming the nanobubble solution includes admixing a water supply and a gas and then passing this admixture through a nozzle adapted to provide the nanobubble solution. This process wherein the water supply is fresh water, brackish water, flow back water, produced water, or a mixture thereof. This process wherein the water supply is a cleaned flow back water, produced water, or mixture thereof.

In another example, the process can include increasing the concentration of nanobubbles in the subterranean formation, up to saturating the water in the subterranean formation with nanobubbles, prior to hydraulically fracturing the subterranean formation. Preferably, increasing the concentration of the nanobubble sin the formation breaks any emulsion in an oil-based mud within the subterranean formation.

Still further, the process can include extracting oil from the fractured subterranean formation. After extracting oil, the process can include separating extracted oil and water thereby providing an oil outflow and produced water. In another instance, the produced water is used to form a produced water-nanobubble solution and this solution can be injected into the subterranean formation. Then, preferably, oil is extracted or further extracted from the subterranean formation into which the produced water-nanobubble solution was injected.

As used herein, a nanogas solution is a homogeneous mixture of nanobubbles and water. The term “nanobubbles” means bubbles of a gas within a liquid, wherein the bubbles having an average diameter of about 10 nm to 100 nm; preferably, wherein there are no bubble having a diameter of greater than about 500 nm, about 400 nm, about 300 nm, about 250 nm, or about 200 nm, more preferably, there are no microbubbles. Nanogas solutions have been formed in or by a nanogas solution generator, one example of which is provided in U.S. Pat. No. 9,586,176 which is incorporated herein in its entirety, an additional generator is described in U.S. Pat. No. 8,500,104.

The nanogas solution is preferably homogeneous, that is, the nanobubbles are evenly distributed throughout the solution and appear as a suspended “particulate” in the liquid. Notably, the liquid may further be saturated with or near saturation with the gas that comprises the nanobubbles. A mixture of bubbles and liquid wherein the bubbles coalesce and/or rise to the surface and break is not a homogeneous mixture of nanobubbles and the liquid.

The nanogas solution can include nanobubbles that include, consist essentially of, or consist of oxygen (O₂), nitrogen (N₂), carbon dioxide (CO₂), or a mixture thereof; and can include a liquid that is water, for example, distilled water, di-water, ground water, municipal water, collected water, produced water, or recycled water. As used herein, the terms oxygen and nitrogen refer to the gasses O₂ and N₂ whether or not the term oxygen gas or nitrogen gas is used.

In one instance, the nanogas solution includes collected water; as used herein collected water means the water that has been used in the oil industry for the hydraulic fracturing of subterranean formations, well stimulation or treatment, specifically water that has been collected from a subterranean use. In another instance the nanogas solution includes produced water; as used herein produced water means the water that has been collected from a subterranean formation (e.g., coming naturally from a formation that contains oil or solids). In yet another instance, the nanogas solution includes recycled water, as used herein recycled water means collected water which has been processed to remove oil and solids.

In yet another instance the nanogas solution includes oxygen, nitrogen, carbon dioxide, or a mixture thereof. In one example, the nanogas solution is a nitrogen-nanogas solution wherein the solution includes, consists essentially of, or consists of nitrogen (N₂) and the water. Herein, the term consists essentially of refers to the inclusion of salts, gases, or solutes that may occur in the water (liquid) but have no effect on the performance of the nanogas solution in the herein disclosed processes. Notably, unless rigorously cleaned and degassed, water will always include some concentration of contaminants (solutes and gases). Furthermore, the term consisting essentially of includes the use of recycled water for the formation of the nanogas solution; in this instance, the solution will consist of the gas, water (H₂O), and minor concentrations of compounds found in the emulsion from which the recycled water was obtained. Herewith, the nanogas solution preferably consists essentially of the gas and water, wherein the contaminants in the water do not affect the performance of the solution. In another example, the nanogas solution is an oxygen-nanogas solution wherein the solution includes, consists essentially of, or consists of oxygen and water. In still another example, the nanogas solution is a ON-nanogas solution wherein the solution includes, consists essentially of, or consists of oxygen, nitrogen, and water. Herein, an ON-nanogas includes molar ratios of oxygen to nitrogen of 99:1 to 1:99, for example 99:1, 90:1, 80:1, 70:1, 60:1, 50:1, 40:1, 30:1, 20:1, 10:1, 1:1, 1:10, 1:20, 1:30, 1:40, 1:50, 1:60, 1:70, 1:80, 1:90, and 1:99. Preferred molar ratios include about 18:82, 21:79, 28:72, 30:70, 32:68, 35:65, 40:60, 42:58, and 50:50. Other particularly relevant molar ratios can be selected from 50:50; 60:40; 70:30; and 80:20. In yet still another example, the nanogas solution includes carbon dioxide wherein the solution includes, consists essentially of, or consists of carbon dioxide and water, more preferably a mixture of carbon dioxide, nitrogen, and water.

Preferably, the subterranean formation has been charged with a nitrogen-nanogas solution. That is, prior to or concurrent with fracking the subterranean formation was charged with a nitrogen-nanogas solution. In another preferable instance, the subterranean formation had been charged with a carbon dioxide nanogas solution. Even more preferably, the subterranean formation was charged with a nitrogen-nanogas solution and a carbon dioxide nanogas solution prior to hydraulically fracturing the subterranean formation.

Herein, the fracking can be an initial fracturing, secondary fracturing of a producing or formerly producing formation, or during a secondary production phase (secondary recovery); and/or during a tertiary production phase (Enhanced Oil Recovery “EOR”). Notably, during a tertiary production phase, the subterranean formation can be charged with the nanogas solution prior to or concurrent with standard EOR processes.

In another instance, the process includes injecting into the subterranean formation the nitrogen-nanogas solution and can include injecting into the subterranean formation a carbon dioxide nanogas solution. Notably, the nitrogen and the carbon dioxide solutions can be co-injected or separately injected in the subterranean formation. The separate injection can include temporal or location distinctions, that is, the nitrogen and carbon dioxide solutions can be injected at the same time but at different locations and/or one solution can be injected earlier than the other. In one instance, multiple injections of the solutions can incur with alternating solution compositions. In one preferable instance, the nitrogen-nanogas solution is co-injected into the subterranean formation with a carbon dioxide nanogas solution.

Herein, the injection of the nanogas solution into the subterranean formation includes providing a pressurized admixture of the gas and water to an injection nozzle positioned within the subterranean formation. Notably, the nanogas solution utilized herein is manufactured, made, or generated downhole (i.e., within the subterranean formation) and is not produced above ground. Accordingly, in one instance, a pressurized admixture of nitrogen and water is provided to an injection nozzle positioned within the subterranean formation wherein the injection nozzle converts the pressurized admixture into a nanogas solution. In another instance, the pressurized admixture includes carbon dioxide. In yet another instance, the pressurized admixture includes a salt, preferably salt or salts that prevent the dissolution of the formation and/or assist in the disruption of the hydrocarbon from the formation.

In one instance the process can include conveying the pressurized admixture of nitrogen and water through a pipe from an above-ground proximal end of the pipe to a downhole terminal end of the pipe, wherein the terminal end is disposed in the subterranean formation. Then subjecting the pressurized admixture to a plurality of alternating flow regions in a tool in communication with the pipe and disposed at or near the terminal end of the pipe, wherein the flow regions each include a plurality of laminar flow regions and turbulent flow regions configured to produce a nanogas solution from the pressurized admixture. Then, forming a nanogas solution in the tool, and injecting the nanogas solution from the tool into the formation.

In another instance, the process can include collecting a mixture of the hydrocarbon and water from the subterranean formation; and separating the hydrocarbon and the water. The process of separating the hydrocarbon and the water can include providing the mixture to a separation tank (e.g., a float tank) for a density based separation; can include the addition of an additional nanogas solution to facilitate breaking an emulsion in the mixture; and or dewatering the solution through chemical, mechanical, or thermal processes.

Another embodiment is a process of oil recovery that includes injecting a nanogas solution into a subterranean formation; admixing the nanogas solution and oil in the subterranean formation; forming a lightened oil that has a reduced viscosity and/or density; carrying the lightened oil to a wellbore; and extracting the lightened oil from the wellbore. In one instance, the nanogas solution includes a nitrogen-nanogas solution; in another instance, the nanogas solution includes nitrogen and carbon dioxide.

Preferably, the nanogas solution is injected into the subterranean formation by carrying a pressurized admixture of a gas and water to an injection nozzle positioned within the subterranean formation; passing the pressurized admixture through a tube that includes plurality of alternating flow regions within the injection nozzle; and then ejecting the nanogas solution from the injection nozzle. The injection nozzle, preferably, includes a plurality of tubes, each including a plurality of alternating flow regions and the pressurized admixture is, preferably, passed through this plurality of tubes. In one instance, the nanogas solution is injected into the subterranean formation by carrying a pressurized admixture of a gas and water through a pipe from an above-ground proximal end of the pipe to a downhole terminal end of the pipe, wherein the terminal end is disposed in the subterranean formation. The pressurized admixture is then subjected to a plurality of alternating flow regions in a tool in communication with the pipe and disposed at or near the terminal end of the pipe, wherein the alternating flow regions are configured to produce a nanogas solution from the pressurized admixture. The nanogas solution is then formed in the tool and, finally, is injected from the tool into the formation.

In another instance, the oil recovery is an EOR process that includes carbon dioxide flooding of the subterranean formation. In one preferable example, the oil recovery includes both carbon dioxide flooding and injection of the nanogas solution. In another preferable example, the process includes alternating the carbon dioxide flooding and the injection of the nanogas solution, providing a plurality of both.

The process includes lightening the oil in the subterranean formation. Herein, this means, the density and/or viscosity of the oil in the formation is changed to facilitate the movement of the oil in the formation. Preferably, the density and/or the viscosity is/are decreased. Once the oil is lightened, this lightened oil is carried to a wellbore (extraction point) and removed from the subterranean formation. Preferably, the extracted lightened oil includes a lower concentration of solids, asphaltenes, paraffins, resins, and mixtures thereof than oil extracted from the subterranean formation prior to the addition of the nanogas solution. In one example, the concentration of solids, asphaltenes, paraffins, resins, and mixtures thereof is decreased by at least 5%, 10%, 15%, 20%, 25%, 30%, 35%, 40%, 45%, or 50%. In another instance, the extracted lightened oil can have an API above 23°, preferably above 25°, above 27°, or above 30°. That is, the weight of the oil extracted from the subterranean formation, when measured without additional steps following the extraction, has an API, preferably above 23°. Notably, the extracted lightened oil can be further processed to remove additional solids, gases, and water to provide the crude oil. This crude oil can have an API that is less than 22°, that is the crude oil is a heavy oil. In one instance, this heavy oil has an API less than 22°, less than 20°, less than 18°, less than 16°, less than 14°, or less than 12°.

In another instance the lightened oil carried from the wellbore is an admixture of water and oil. The water preferably includes a concentration of nanobubbles (e.g., nitrogen nanobubbles). The oil can include a concentration of carbon dioxide dissolved therein. Preferably the lightened oil includes a concentration of carbon dioxide but is collected from the wellbore with a minimum (less than 50 wt. %, 40 wt. %, 30 wt. %, 20 wt. %, 10 wt. % or 5 wt. %) of water. More preferably, when water is extracted from the wellbore with the lightened oil this mixture does not include an oil-in-water emulsion. That is, the addition of the nitrogen nanogas solution suppresses or prevents the formation of an oil-in-water emulsion in the subterranean formation and decreases or prevents the collection of the oil-in-water emulsion from the wellbore.

Importantly, the machines and processes provided herein provide nanogas solutions without macrobubbles and/or without the formation of macrobubbles. Preferably, none of the nanogas solutions utilized herein form or include macrobubble (i.e., any bubble larger than a nanobubble).

An ON-nanogas solution is a solution that includes, consists essentially of, or consists of oxygen (O₂), nitrogen (N₂), and water. Herein, an ON-nanogas includes molar ratios of oxygen to nitrogen in the range of 99:1 to 1:99; examples include 99:1, 90:1, 80:1, 70:1, 60:1, 50:1, 40:1, 30:1, 20:1, 10:1, 1:1, 1:10, 1:20, 1:30, 1:40, 1:50, 1:60, 1:70, 1:80, 1:90, and 1:99. Preferred molar ratios include about 18:82, 21:79, 28:72, 30:70, 32:68, 35:65, 40:60, 42:58, and 50:50. One particularly relevant molar ratio is 21:79 (air). Other particularly relevant molar ratios can be selected from 50:50; 60:40; 70:30; and 80:20. In particular, the amount of oxygen (relative to the amount of nitrogen) can be varied to achieve different results, and the higher the concentration of the composition that is desired to be oxidized the higher the oxygen concentration can be. In one instance, the addition of the oxygen nanogas solution to the landfill promotes the oxygenation of sulfides in the landfill and the reduction of noxious gases from the waste mass.

A preferable embodiment includes hydraulically fracturing a subterranean formation with a fracking fluid that includes nanobubbles. In one instance, this embodiment includes forcing the nanobubbles into fractures; once therein, the nanobubbles preferably function as proppants within the fractures. These fracture-positioned nanobubbles can additionally be expanded by reducing the pressure within the subterranean formation (an effect of external pressure on the diameter of the nanobubble). This expansion of the nanobubble diameter, preferably, provides a secondary expansion of the fractures.

In one example, the fracking fluid is provided by first forming a nanogas solution that include nanobubbles and a solvent (liquid, e.g., water) external to the subterranean formation, then forming the fracking fluid with the nanogas solution. This fracking fluid is then pumped into the subterranean formation; and thereafter the subterranean formation is hydraulically fractured. Notably, fracking fluid (hydraulic fracturing fluid) is typically composed of 98 to 99.5 wt. % water and proppant (e.g., sand) with 0.5 to 2 wt. % additive; where can include, for example, biocides, scale inhibitors, solvents, friction reducers, additives, corrosion inhibitors, and non-ionic surfactants.

In one instance, the nanogas solution can be formed or provided by admixing a water supply and a gas and then passing this admixture through a nozzle adapted to provide the nanogas solution. The water can be fresh water, brackish water, flow back water, produced water, or a mixture thereof. In one instance, the water is a cleaned flow back water, produced water, or mixture thereof. As used herein, “cleaned” flow back or “cleaned” produced water means that solids have been removed (e.g., dropped out) of the flow back or produced water. Preferably, “cleaned” water also has a percentage (e.g., 10%, 25%, 50%, 75%, or about 100%) of an entrained oil removed from the water. Even more preferably, “cleaned” water further has corrosive gasses (e.g., sulfides) removed or sparged from the water. In another instance, the fracking fluid or a portion of the fracking fluid can be converted into the nanogas solution. In this instance, the nanogas solution is formed or provided by admixing the fracking fluid (or portion thereof) and a gas, and then passing this admixture through a nozzle adapted to provide the nanogas solution.

Notably, the nanogas solution can be injected into the subterranean formation prior to fracturing, as a fracturing fluid, or both prior to fracturing and as a fracturing fluid. In one example, the process includes adding the nanogas solution to the subterranean formation prior to fracking. This example can include injecting a nanogas solution that includes nanobubbles and water into the subterranean formation until a subterranean water includes a minimum concentration of nanobubbles. Preferably, the minimum concentration of the nanobubbles in the subterranean water is at least 0.0025% of a concentration of nanobubbles in the nanogas solution; more preferably, at least 0.005%, 0.01%, 0.05%, 0.1%, 0.5%, 1%, 2%, 3%, 4%, 5%; 6%, 7%, 8%, 9%, 10%, 15%, 20%, 30%, 40%, or 50% of the concentration of the nanobubbles in the nanogas solution. In one instance, the subterranean water can be recirculated through a process of forming a nanogas solution (forming nanobubbles) and injecting this nanogas solution into the subterranean formation until the concentration of nanobubbles in the formation are at the desired level. Thereafter, the process can include providing the fracking fluid to the subterranean formation; and the hydraulically fracturing the subterranean formation. Additionally, the process of providing the nanobubbles to the subterranean formation can provide or the process can include breaking an emulsion in an oil-based mud within the subterranean formation.

Yet another embodiment includes forming a pressurized admixture of a gas and water; then converting the pressurized admixture to a nanogas solution which includes nanobubbles and water. This nanogas solution is then injected into a subterranean formation and then the subterranean formation that includes the nanogas solution is hydraulically fractured. In one example of this embodiment, the process can include injecting a fracking fluid into the subterranean formation after injecting the nanogas solution and then hydraulically fracturing the subterranean formation. In another example, the process can feature a fracking fluid that includes nanobubbles.

In another example of this process the steps of forming a pressurized admixture of a gas and water; converting the pressurized admixture to a nanogas solution which includes nanobubbles and water; and injecting the nanogas solution into a subterranean formation, can include withdrawing a portion of a subterranean water that includes solids and salts. Then separating the solids from the subterranean water, typically leaving the salts in this withdrawn water, thereby providing separated subterranean water or, simply, clarified water. The process can then include forming a pressurized admixture of the gas and the separated subterranean water which is converted into the nanogas solution which includes nanobubbles and water. The process can then feature injecting this nanogas solution into the subterranean formation until the subterranean water includes a minimum concentration of nanobubbles that is at least 0.0025% of a concentration of nanobubbles in the nanogas solution.

Yet another embodiment is a process that includes injecting a nanogas solution into a subterranean formation until the subterranean water includes a minimum concentration of nanobubbles, wherein the minimum concentration of the nanobubbles in the subterranean water is at least 0.0025% of a concentration of nanobubbles in the nanogas solution; and then hydraulically fracturing the subterranean formation that includes the nanogas solution. This process can further include injecting a fracking fluid into the subterranean formation and thereafter hydraulically fracturing the subterranean formation. In one instance, the fracking fluid includes nanobubbles and proppants. In another instance, the fracking fluid is substantially free of nanobubbles. In yet another instance, the fracking fluid includes nanobubbles and is substantially free of proppants.

One example of the hydraulic fracturing process starts with cleaning the water. Clean water can be fresh, produced, brackish, flow back water, or combinations thereof, that is charged with nanobubbles. Herein, it was observed that the addition of nanobubbles to water can drop the solids, reduce the total dissolved solid (TSS), and/or remove hydrocarbons, thereby providing “clean” water that includes a concentration of nanobubbles.

This (clean) treated nanobubble water can be infused with biocides, surfactants, friction reducers and other chemicals while pumping the water downhole into formation (e.g., as a fracking fluid). Herewith, it was observed that the nanobubbles can increase the performance of certain frack chemicals, thereby reducing the amount of said chemicals needed per frack. In one instance, the nanobubble water can be gelled and crosslinked to carry proppants or can be used as a slickwater frac. Herewith, it was observed that high salinity brine can be gelled and crosslinked when infused with nanobubbles. Moreover, it was observed that the nanobubbles can be used to break emulsions in an oil-based drilling fluid (e.g., oil based mud). Further, nanobubbles can be used to break the oil-based mud in the formation at the beginning of the fracking process.

In certain circumstances, the pressure down-hole shrinks the size of the bubble. In doing so, it is believed that the internal pressures of the bubble increases making the bubble very hard, offsetting the external pressure, and as such the bubble will not pop and saturate into the water. It is further believed that the increased pressure in the bubble allows the bubble to behave as a proppant in the formation. As a gas proppant it is lighter than a solids proppant which allows the bubble to flow easily with the water helping with friction reduction in comparison to other proppants. Preferably, the nanobubbles are hard enough to support the formation in large volumes, holding the fractures open and allowing the oil and water to release from the formation. While total life expectancy of a subterranean nanobubble is not known; nanobubbles in surface enclosures have been confirmed to last over two years. Accordingly, subterranean nanobubbles, under pressure, can have prolonged half-lives.

In one instance, nanobubbles can reduce interfacial tension breaking the emulsions and releasing capillary pressures at the pores. Preferably, the nanobubbles can enter small fractures and pores where standard proppants can't go, propping and holding them open. Notably, should any Nanobubble fail and pop, there is not any residual material or fines to clog up the pore or formation.

Lastly, cleaning the oil water emulsions at the surface, saturating the removed water and replacing it down hole in the formation through tubing or a down-hole nanobubble generator tool will maintain the nanobubbles in the formation keeping the fissures and pores open.

While the compositions and methods of this invention have been described in terms of preferred embodiments, it will be apparent to those of skill in the art that variations may be applied to the compositions and/or methods in the steps or in the sequence of steps of the method described herein without departing from the concept, spirit and scope of the invention. More specifically, it will be apparent that certain agents that are both chemically and physically related may be substituted for the agents described herein while the same or similar results would be achieved. All such similar substitutes and modifications apparent to those skilled in the art are deemed to be within the spirit, scope and concept of the invention as defined by the appended claims.

What is claimed:

1. A process comprising:
hydraulically fracturing a subterranean formation with a fracking fluid that includes nanobubbles.

2. The process of claim 1, wherein hydraulically fracturing the subterranean formation includes forcing the nanobubbles into fractures.

3. The process of claim 2, wherein the nanobubbles function as proppants within the fractures.

4. The process of claim 3 further comprising reducing the pressure within the subterranean formation and expanding a diameter of the nanobubbles, thereby expanding the fractures.

5. The process of claim 1, wherein providing the fracking fluid includes
forming a nanogas solution that include nanobubbles and a solvent external to the subterranean formation,
forming the fracking fluid with the nanogas solution, and
pumping the fracking fluid into the subterranean formation; and thereafter
hydraulically fracturing the subterranean formation.

6. The process of claim 5, wherein forming the nanogas solution includes admixing a water supply and a gas and then passing this admixture through a nozzle adapted to provide the nanogas solution.

7. The process of claim 6, wherein the water supply is fresh water, brackish water, flow back water, produced water, or a mixture thereof.

8. The process of claim 7, wherein the water supply is a cleaned flow back water, produced water, or mixture thereof.

9. The process of claim 1 further comprising
injecting a nanogas solution that includes nanobubbles and water into the subterranean formation until a subterranean water includes a minimum concentration of nanobubbles;
wherein the minimum concentration of the nanobubbles in the subterranean water is at least 0.0025% of a concentration of nanobubbles in the nanogas solution; thereafter
providing the fracking fluid to the subterranean formation; and thereafter hydraulically fracturing the subterranean formation.

10. The process of claim 9 further comprising breaking an emulsion in an oil-based mud within the subterranean formation.

11. A process comprising:
forming a pressurized admixture of a gas and water; then
converting the pressurized admixture to a nanogas solution which includes nanobubbles and water;
injecting the nanogas solution into a subterranean formation; and then
hydraulically fracturing the subterranean formation that includes the nanogas solution.

12. The process of claim 11 further comprising injecting a fracking fluid into the subterranean formation after injecting the nanogas solution; and then hydraulically fracturing the subterranean formation.

13. The process of claim 11, wherein forming a pressurized admixture of a gas and water; then converting the pressurized admixture to a nanogas solution which includes nanobubbles and water; and injecting the nanogas solution into a subterranean formation, comprises:
the withdrawing a portion of a subterranean water that includes solids and salts;
separating the solids from the subterranean water while leaving the salts; then
forming a pressurized admixture of the gas and the separated subterranean water; then
converting the pressurized admixture to the nanogas solution which includes nanobubbles and water; and then
injecting the nanogas solution into the subterranean formation until the subterranean water includes a minimum concentration of nanobubbles that is at least 0.0025% of a concentration of nanobubbles in the nanogas solution.

14. A process comprising:
injecting a nanogas solution into a subterranean formation until the subterranean water includes a minimum concentration of nanobubbles, wherein the minimum concentration of the nanobubbles in the subterranean water is at least 0.0025% of a concentration of nanobubbles in the nanogas solution; and then
hydraulically fracturing the subterranean formation that includes the nanogas solution.

15. The process of claim 14, further comprising injecting a fracking fluid into the subterranean formation and thereafter hydraulically fracturing the subterranean formation.

16. The process of claim 15, wherein the fracking fluid includes nanobubbles and proppants.

17. The process of claim 15, wherein the fracking fluid is substantially free of nanobubbles.

18. The process of claim 15, wherein the fracking fluid includes nanobubbles and is substantially free of proppants.
